(19) United States
(12) Patent Application Publication
(10) Pub. No.: US 2026/0184169 A1
(43) Pub. Date: Jul. 2, 2026

(54) AUGMENTED-REALITY ASSISTANCE TO VISUALIZE ASSIGNMENT ZONES

(71) Applicant: AT&T Intellectual Property I, L.P., Atlanta, GA (US)

(72) Inventors: Eric Zavesky, Austin, TX (US); Ginger Chien, Bellevue, WA (US); Zhi Cui, Sugar Hill, GA (US)

(21) Appl. No.: 19/006,984

(22) Filed: Dec. 31, 2024

(51) Int. Cl. B60K 35/28; B60K 35/80

(52) U.S. Cl. CPC B60K 35/28; B60K 35/80; B60K 2360/177; B60K 2360/1868; B60K 2360/191; B60K 2360/592

(57) ABSTRACT

A method includes monitoring at least one location based signal for a vehicle, using at least one on-board sensor of the vehicle to determine a location of the vehicle, determining at least one assignment zone for the vehicle based on static map data, generating an augmented reality view of the location surrounding the vehicle, using the static map data for highlighting the at least one assignment zone at the location surrounding the vehicle, and displaying the augmented reality view of the location surrounding the vehicle with the at least one assignment zone being highlighted on a display within the vehicle is disclosed.

The present disclosure relates generally to augmented reality, and relates more particularly to systems, non-transitory computer-readable media, and methods for using augmented reality to improve visibility of assignment zones to assist first responders to quickly visualize changing assignment zones due to dynamically changing events.

### BACKGROUND

Augmented reality (AR) is a specific instance of extended reality technology in which computer-generated virtual objects may be inserted into a view of a real world environment. For instance, a computer generated overlay may be superimposed over an image of a real world environment in order to present an AR experience. Thus, AR may be used to provide immersive entertainment experiences (e.g., gaming, movies, or the like), to simulate conditions for training exercises (e.g., for emergency responders, medical personnel, or the like), to improve e-commerce experiences (e.g., by enabling shoppers to customize items and view those items under different conditions), and to enhance other applications.

### SUMMARY

The present disclosure describes a device, computer-readable medium, and method for using augmented reality to improve visibility of assignment zones to assist first responders to quickly visualize changing assignment zones due to dynamically changing events. A method performed by a processing system including at least one processor includes monitoring at least one location based signal for a vehicle, using at least one on-board sensor of the vehicle to determine a location of the vehicle, determining at least one assignment zone for the vehicle based on static map data, generating an augmented reality view of the location surrounding the vehicle, using the static map data for highlighting the at least one assignment zone at the location surrounding the vehicle, and displaying the augmented reality view of the location surrounding the vehicle with the at least one assignment zone being highlighted on a display within the vehicle.

In another example, a non-transitory computer-readable storage medium stores instructions which, when executed by a processing system including at least one processor, cause the processing system to perform operations. The operations include monitoring at least one location based signal for a vehicle, using at least one on-board sensor of the vehicle to determine a location of the vehicle, determining at least one assignment zone for the vehicle based on static map data, generating an augmented reality view of the location surrounding the vehicle, using the static map data for highlighting the at least one assignment zone at the location surrounding the vehicle, and displaying the augmented reality view of the location surrounding the vehicle with the at least one assignment zone being highlighted on a display within the vehicle.

In another example, a system includes a processing system including at least one processor and a non-transitory computer-readable storage medium storing instructions which, when executed by the processing system, cause the processing system to perform operations. The operations include monitoring at least one location based signal for a vehicle, using at least one on-board sensor of the vehicle to determine a location of the vehicle, determining at least one assignment zone for the vehicle based on static map data, generating an augmented reality view of the location surrounding the vehicle, using the static map data for highlighting the at least one assignment zone at the location surrounding the vehicle, and displaying the augmented reality view of the location surrounding the vehicle with the at least one assignment zone being highlighted on a display within the vehicle.

### BRIEF DESCRIPTION OF THE DRAWINGS

The teachings of the present disclosure can be readily understood by considering the following detailed description in conjunction with the accompanying drawings, in which:

FIG. 1 illustrates an example system in which examples of the present disclosure for using augmented reality to improve visibility of assignment zones to assist responders to quickly visualize changing assignment zones due to dynamically changing events may operate;

FIG. 2 illustrates a flowchart of an example method for using augmented reality to improve visibility of assignment zones to assist first responders to quickly visualize changing assignment zones due to dynamically changing events;

FIG. 3A illustrates an example in which a part of the road is normally seen through a car's windshield;

FIG. 3B illustrates an augmented reality view of the road of FIG. 3A, in which assignment zones may be digitally highlighted so that the assignment zones become readily visible;

FIG. 4 illustrates a flowchart of another example method for using augmented reality to improve visibility of assignment zones to assist first responders to quickly visualize changing assignment zones due to dynamically changing events; and

FIG. 5 depicts a high-level block diagram of a computing device specifically programmed to perform the functions described herein.

To facilitate understanding, identical reference numerals have been used, where possible, to designate identical elements that are common to the figures.

### DETAILED DESCRIPTION

In one example, the present disclosure provides systems, non-transitory computer-readable media, and methods for using augmented reality to improve visibility of assignment zones to assist first responders (e.g., providers of emergency services such as police officers, firemen, medics, etc.) to quickly visualize changing assignment zones due to dynamically changing events. As discussed above, augmented reality (AR) is a specific instance of extended reality technology in which computer-generated virtual objects may be inserted into a view of a real world environment. For instance, a computer generated overlay may be superimposed over an image of a real world environment in order to present an AR experience. Thus, AR may be used to provide immersive entertainment experiences (e.g., gaming, movies, or the like), to simulate conditions for training exercises (e.g., for emergency responders, medical personnel, or the like), to improve e-commerce experiences (e.g., by enabling shoppers to customize items and view those items under different conditions), and to enhance other applications.

Examples of the present disclosure use AR technology to assist drivers (e.g., first responders) to quickly visualize changing assignment zones due to dynamically changing events. For instance, dynamically changing events such as an emergency event at a particular location (e.g., 1—a weather related event such as downed power lines, flooded streets, collapsed buildings, etc. ; 2—a security related event such as an intruder at a school, at a secured government building, at an airport, etc., 3—a medical related event such a person suffering from a medical illness emergency, and 4—a traffic related event such a car accident) or a dynamically changing non-emergency event at a particular location (e.g., a school recess or ending event where children are released to go home, an ending of a concert or performance where a large crowd is expected to be released onto the streets surrounding the venue, the gathering of people for an unscheduled rally, and the like) may require that first responders will be dynamically reassigned to different locations to support such dynamic events.

For example, each first responder (e.g., a police officer, a medic or a fireman) or a responder vehicle (e.g., a police cruiser (with any number of occupying police officers), an ambulance (with any number of occupying medical personnel), a fire truck (with any number of occupying firemen)) may be assigned a “beat” (broadly an assignment zone) in which the first responder is responsible to handle any events during a normal shift of work for each first responder. Although this beat is normally well defined as to its geographical boundaries, during a dynamically changing event such geographical boundaries may be altered (e.g., enlarged or reduced). To illustrate, a fire department of a first town may be dispatched to a remote location (e.g., assisting a wild fire from a neighboring county), but in doing so its own town is now vulnerable to not having any protection against a fire event. As a result a neighboring fire department of a second town may be assigned the duty of protecting the first town. Similarly, personnel of a police department of a first town may be dispatched to a remote location (e.g., assisting a security event at an airport or a detention facility from a neighboring county), but in doing so its own town is now vulnerable to not having any police protection. As a result a neighboring police department of a second town may be assigned the duty of protecting the first town with its own police force. Similarly, a town may dedicate a significant amount of its first responders to a dynamically changing event, e.g., 80% of its first responders, resulting in its remaining 20% of first responders having to fill-in the duties of its other first responders who have been re-assigned to other duties. Such dynamic reassignments may cause a significant amount of confusion that may lead to unintended consequences, e.g., failure to properly respond to emergencies due to reassigned first responders' duties not being properly handled by other backup first responders.

Alternative, such dynamic reassignments may also cause a significant amount of confusion that may lead to unintended consequences where a large number of first responders are all approaching a new assignment zone, e.g., responding to an active armed intruder at an airport where first responders from multiple jurisdictions may all converge rapidly at the same location (e.g., a newly assigned zone). Such confusion may entail not knowing which terminal or building that the potential intruder is currently located. Such confusion is often resolved once the first responders are in communication with other first responders present at the location or with dispatchers, but such communications may take some time to coordinate and may cause significant delays.

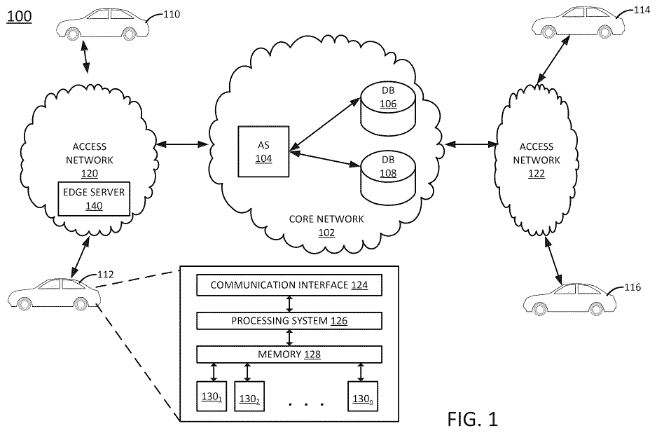

In one example of the present disclosure, assignment zones such as geo-fenced boundaries may be highlighted and displayed on an in-vehicle display (e.g., a heads-up display (HUD), a dashboard display, an AR-enabled windshield, AR-enabled personal eyewear (e.g., smart eye glasses and/or smart goggles), or the like). The AR-enabled highlighting of the assignment zones may be generated using static map data, such as historical street-level views of the environment surrounding the moving vehicle, as well as modification data (e.g., dynamic event or map data, such as real-time traffic conditions and/or locations of target events as reported by a first responder vehicle, e.g., cameras of a police cruiser or a traffic enforcement cruiser or a body camera of a first responder currently at the scene of the new assignment zone). The AR-enabled highlighting of the assignment zones may be updated continuously based on movement of the moving vehicle and changes in the dynamic event data. Thus, the AR-enabled highlighting of the assignment zones may provide an enhanced view of the environment surrounding the moving vehicle, e.g., assisting the first responder as he or she is approaching the assignment zone with clear demarcation (virtually highlighted) of its boundaries. These and other examples of the present disclosure are discussed in greater detail below in connection with FIGS. 1-5.

To further aid in understanding the present disclosure, FIG. 1 illustrates an example system 100 in which examples of the present disclosure for using augmented reality to improve visibility of assignment zones to assist first responders to quickly visualize changing assignment zones due to dynamically changing events may operate. The system 100 may include any one or more types of communication networks, such as a traditional circuit switched network (e.g., a public switched telephone network (PSTN)) or a packet network such as an Internet Protocol (IP) network (e.g., an IP Multimedia Subsystem (IMS) network), an asynchronous transfer mode (ATM) network, a wireless network, a cellular network (e.g., 2G, 3G, and the like), a long term evolution (LTE) network, 5G and the like, related to the current disclosure. It should be noted that an IP network is broadly defined as a network that uses Internet Protocol to exchange data packets. Additional example IP networks include Voice over IP (VoIP) networks, Service over IP (SoIP) networks, and the like.

In one example, the system 100 may comprise a network 102, e.g., a telecommunication service provider network, a core network, an enterprise network comprising infrastructure for computing and providing communications services of a business, an educational institution, a governmental service, or other enterprises. The network 102 may be in communication with one or more access networks 120 and 122, and the Internet (not shown). In one example, network 102 may combine core network components of a cellular network with components of a triple play service network; where triple-play services include telephone services, Internet or data services and television services to subscribers. For example, network 102 may functionally comprise a fixed mobile convergence (FMC) network, e.g., an IP Multimedia Subsystem (IMS) network. In addition, network 102 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. Network 102 may further comprise a broadcast television network, e.g., a traditional cable provider network or an Internet Protocol Television (IPTV) network, as well as an Internet Service Provider (ISP) network. In one example, network 102 may include a plurality of television (TV) servers (e.g., a broadcast server, a cable head-end), a plurality of content servers, an advertising server (AS), an interactive TV/video on demand (VoD) server, and so forth.

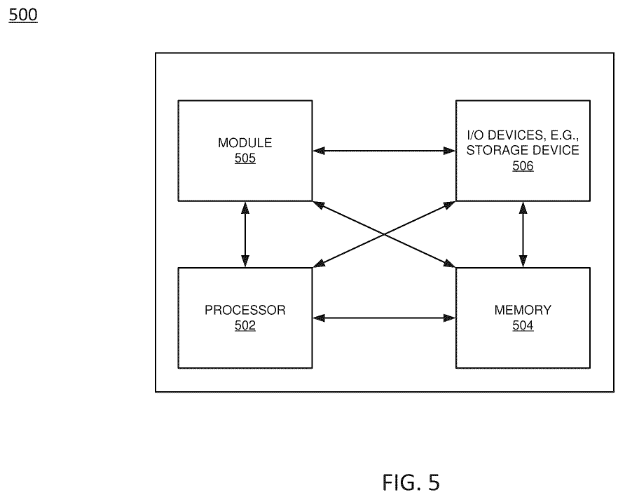

In accordance with the present disclosure, application server (AS) 104 may comprise a computing system or server, such as computing system 500 depicted in FIG. 5, and may be configured to provide one or more operations or functions for using augmented reality to improve visibility of assignment zones to assist first responders to quickly visualize changing assignment zones due to dynamically changing events. It should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 5 and discussed below) or multiple computing devices collectively configured to perform various steps, functions, and/or operations in accordance with the present disclosure.

The AS 104 may be communicatively coupled to one or more databases (DBs) 106 and 108. The DBs 106 and 108 may store data that is used by the AS 104 to perform operations or functions for using augmented reality to improve visibility of assignment zones to assist first responders to quickly visualize changing assignment zones due to dynamically changing events, as described herein. For instance, the DB 106 may store outputs from the on-board sensors of a plurality of vehicles (e.g., outputs from the general public or outputs from first responder vehicles such as police and traffic vehicles), while DB 108 may store historical map data or current map data including street level views of a plurality of locations that will show one or more traffic markers. The DB 106 may be provided in connection with the AS 104 as part of a subscription service for using augmented reality to improve visibility of assignment zones to assist drivers, while the DB 108 may be provided as part of the subscription service or may be provided by a party that is unaffiliated with or independent of the subscription service, e.g., the information stored in DB 108 can be provided by a governmental agency, e.g., a weather forecasting entity (e.g., National Weather Service, National Oceanic, Atmospheric Administration, etc.) or an accident reporting entity (e.g., a local police department, a local fire department, a local ambulatory department, etc.) or a non-governmental agency that provides general mapping and/or street level viewing services. In one embodiment, the current map data may be updated with current reported event updates, e.g., current weather information affecting a roadway, current accident information affecting a roadway, current construction information affecting a roadway, current debris information affecting a roadway, current locations of emergency events (such as a current building where an intruder has been spotted, or current locations of one or more victims), etc. The current information may comprise specific time, roadway location, building location, and/or the exact nature of the dynamically changing event, e.g., an image, or a video of the affected roadway or building.

In a further example, AS 104 may comprise a physical storage device (e.g., a database server), to store various types of information in support of systems for generating data for using augmented reality to improve visibility of assignment zones to assist a driver of a vehicle, in accordance with the present disclosure. For example, AS 104 may store any or all of the information stored by the DB 106 and/or DB 108.

Although only a single application server (AS) 104 and two databases (DBs) 106 and 108 are illustrated in FIG. 1, it should be noted that any number of servers and databases may be deployed. For instance, a plurality of servers and databases may operate in a distributed and/or coordinated manner as a processing system to perform operations for using augmented reality to improve visibility of assignment zones to assist first responders to quickly visualize changing assignment zones due to dynamically changing events, in accordance with the present disclosure. For ease of illustration, various additional elements of network 102 are omitted from FIG. 1.

In one example, the access networks 120 and 122 may comprise broadband optical and/or cable access networks, Local Area Networks (LANs), wireless access networks (e.g., an IEEE 802.11/Wi-Fi network and the like), cellular access networks, Digital Subscriber Line (DSL) networks, public switched telephone network (PSTN) access networks, 3^{rd} party networks, and the like. For example, the operator of network 102 may provide a cable television service, an IPTV service, or any other types of telecommunication service to subscribers via access networks 120 and 122. In one example, the access networks 120 and 122 may comprise different types of access networks, may comprise the same type of access network, or some access networks may be the same type of access network and other may be different types of access networks. In one example, the network 102 may be operated by a telecommunication network service provider. The network 102 and the access networks 120 and 122 may be operated by different service providers, the same service provider or a combination thereof, or may be operated by entities having core businesses that are not related to telecommunications services, e.g., corporate, governmental or educational institution LANs, and the like.

In one example, the access network 120 may be in further communication with a plurality of user endpoint devices (UEs), such as devices 110 and 112. Similarly, access network 122 may be in further communication with a plurality of user endpoint devices (UEs), such as devices 114 and 116. In one example, UEs 110-116 may each comprise a motor vehicle (e.g., a connected car, van, truck, trailer, construction vehicle, bus, or the like), and the like. In further examples, the UEs 110-116 may comprise other types of vehicles such as connected watercraft, aircraft, drone, and the like. By “connected,” it is understood that the vehicle is capable of communicating bidirectionally with external systems (i.e., systems external to the vehicle, including the AS 104 and/or DBs 106 and 108).

FIG. 1 illustrates a view of the UE 112 in more detail. The more detailed view of the UE 112 may also be representative of the UEs 110, 114, and 116; however, it is understood that any of the UEs 110, 112, 114, and 116 may include components in addition to those illustrated in FIG. 1. In one example, each UE 110-116 may comprise at least a communication interface 124, a processing system 126, a memory 128, and one or more on-board sensors 130₁-130ₙ (hereinafter individually referred to as an “on-board sensor 130” or collectively referred to as “on-board sensors 130”). The processing system 126 may be in communication with both the communication interface 124 and the memory 128, while the memory 128 may be in communication with the on-board sensors 130.

The on-board sensors 130 may include one or more different types of sensors for monitoring different conditions within and around a vehicle. In one example, the on-board sensors 130 may include at least one of: a sound navigation ranging (sonar) system, a light detection and ranging (lidar) system, a radar system, a camera (e.g., RGB and/or infrared video camera) system, a video camera, a global positioning system (GPS) receiver (broadly a position signal receiver), a moisture sensor, a proximity sensor, a light sensor, a barometer, a thermometer, an anemometer, or another type of sensor. Each of the on-board sensors 130 may generate as an output measurements of a condition within or around the vehicle (e.g., on a continuous, periodic, or event-driven basis) and may store these measurements in the memory 128. In one example, measurements may remain in the memory 128 until the measurements reach a predefined age (e.g., z minutes) and/or until the measurements are overwritten by more recent measurements. The memory 128 may comprise volatile memory, non-volatile memory, read-only memory (ROM), random access memory (RAM), a magnetic or optical drive, a device or diskette, and/or any combination thereof.

The processing system 126 may comprise, in one example, an on-board computing system or controller of a vehicle (e.g., an electronic control unit (ECU) or an electronic control module (ECM)). The processing system 126 may retrieve measurements observed by the on-board sensors 130 from the memory 128 and may process the measurements in order to make inferences about the conditions surrounding the vehicle, conditions within the vehicle including an occupant's line of sight, and/or current location of the vehicle and its relationship to an assignment zone. For instance, if the measurements include camera images of the road ahead of the vehicle including lanes of the way and/or surrounding landscapes, then the processing system 126 may infer and present one or more assignment zones ahead of the vehicle. The processing system 126 may also obtain various measurements and infer the gaze or line of sight of one or more occupants within the vehicle, to control the highlighting of assignment zones using AR.

The communication interface 124 may comprise any type of interface to establish a wireless communication session with the access network 120 and core network 102. In one example, the communication interface 124 may be a wireless network card that can wirelessly connect to a local WIFI network. In one example, the communication interface, e.g., a transceiver, may establish a communication session between the vehicle and the DBs 106 or 108 in order to transmit measurements observed by the on-board sensors 130 from the memory 128 to the DB 106 and also to receive information and data from the DBs 106 or 108.

In a further example, when the processing system 126 detects that the visibility of the vehicle's assignment zone is likely to be changed relative to the location of the vehicle, the communication interface 124 may establish a communication session between the vehicle and the AS 104 in order to acquire data (e.g., modification data or modification instruction) to assist the processing system 126 in generating an AR view of the conditions surrounding the vehicle. More specifically, the acquired data will allow the processing system 126 to generate the AR view that uses augmented reality to improve visibility of assignment zones to assist drivers in navigating to and from the assignment zones (e.g., an AR view where assignment zones (e.g., geo-fenced areas) are virtually highlighted (e.g., a virtual image of the relevant boundary markers are superimposed or overlaid onto the display or windshield of the vehicle)). This AR view may be displayed on a display inside the vehicle, such as a heads up display, a dashboard display, an AR-enabled windshield, or the like. Thus, the AR view may help the driver to quickly visualize the boundaries of the assignment zones, thereby allowing the driver to provide needed services to the people in the one or more assignment zones.

It should also be noted that the system 100 has been simplified. Thus, it should be noted that the system 100 may be implemented in a different form than that which is illustrated in FIG. 1, or may be expanded by including additional endpoint devices, access networks, network elements, application servers, etc. without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements. For example, the system 100 may include other network elements (not shown) such as border elements, routers, switches, policy servers, security devices, gateways, a content distribution network (CDN) and the like. For example, portions of network 102, access networks 120 and 122, and/or Internet may comprise a content distribution network (CDN) having ingest servers, edge servers, and the like for packet-based streaming of video, audio, or other content. Similarly, although only two access networks, 120 and 122 are shown, in other examples, access networks 120 and/or 122 may each comprise a plurality of different access networks that may interface with network 102 independently or in a chained manner. In one example, the system 100 may further include wireless or wired connections to sensors, radio frequency identification (RFID) tags, or the like from which devices may determine locations/positions, ranges/distances, bearings, and so forth. Thus, these and other modifications are all contemplated within the scope of the present disclosure.

In one embodiment, the gaze or line of sight of the occupant(s) of the vehicle can be tracked using one or more internal sensors, e.g., one or more cameras and infrared or near-infrared illuminating sources, facing into the cabin of the vehicle. For example, the gaze of the driver or a passenger sitting next to the driver will be tracked to determine their line of sights. In this illustrative embodiment, the line of sight of an occupant of the vehicle will allow the proper placement of a projection of an image onto a vehicle's windshield or a panel just beneath an occupant's line of sight, e.g., a projection from a heads-up display unit on the vehicle. In other words, the projection of the image by the heads-up display unit onto the vehicle's windshield can be continuously adjusted to accommodate the occupant's shifting gaze. In one embodiment, the projection includes the highlighting of the assignment zones. Thus, as the occupant's gaze is shifting, the projection including the highlighting of the assignment zones is also shifted in the same direction in a coordinated manner so the occupant will be able to see the highlighted assignment zones.

Various gaze tracking methods can be used, where gaze tracking is a method to monitor eye activity (e.g., of an occupant of the vehicle), including eye movements, point of gaze, pupil dilation, blinking, etc. Such method relies on eye tracking devices that use sensors to follow the eyes' movement and determine where a person is looking at (e.g., the point of gaze). In other words, eye tracking identifies and monitors a person's visual attention in terms of location, objects, and duration. For example, eye tracking may operate by following the eye position and movements in a non-intrusively manner. In one example, a source of infrared light can be used to illuminate the pupil, where a reflection is generated on the cornea. An infrared camera can then be used to record the reflection, determine the center of the pupil, determine eye rotation, thereby determining the gaze direction.

In other words, the vehicle (e.g., vehicle 112) may be equipped with one or more sensor clusters that are positioned so as to be able to sense an occupant's face (e.g., the vehicle operator's face). In one embodiment, the sensors (130₁-130n) in a cluster may include video cameras, audio microphones, image cameras, sonar sensors, light detection and ranging (lidar) sensors, or other such sensors that may be used to detect the distance of the face from the sensor cluster. This sensor cluster is in communication with the onboard computer or processing system 126 or an edge server 140 deployed at the edge of the access network 120. The sensor cluster may continuously deliver sensor readings to the processing system 126 and/or the edge server 140 for analysis. For example, the processing system 126 and/or the edge server 140 may be equipped with a software application to analyze video along with sonar or other data that is indicative of the user's distance from the sensor cluster. In doing so, the processing system 126 and/or the edge server 140 may determine the location of each of the occupant's eyeballs within the cabin of the vehicle along with the direction of view of each eyeball at any given point in time. In one embodiment, the locations of one or more sensors of the sensor cluster within the cabin are known and predefined. Therefore, the sensor cluster or the processing system 126 will know the sensor cluster's location in three dimensions at any point in time. Therefore, the location in three dimensions of each eyeball may also be determined at any point in time as well, based on the sonar, light detection and ranging (lidar) or other such sensor data.

Furthermore, the cameras located in the sensor cluster may also send video to the processing system 126 and/or the edge server 140 which may also have image analysis capabilities so as to detect the orientation of the occupant's line of sight with respect to the location of each eyeball by detecting the orientation of the pupil of each eyeball. Using this data, the processing system 126 and/or the edge server 140 may detect a focal point at any given point in time for the occupant (e.g., relative to a point on the fixed windshield of the vehicle). This calculated focal point in three dimensions relative to the windshield display can be used to control the placement of the projection(s) or overlay(s) of the heads-up display unit to follow the gaze(s) of the occupant(s) (e.g., a driver and/or a passenger sitting in the front seat next to the driver). In one embodiment, two heads-up display units can be deployed to provide two separate distinct projects (one projection for the driver and another projection for a passenger sitting in the front seat next to the driver). This arrangement will allow each of the two occupants to follow his or her own heads-up display unit's projection or overlay, thereby enabling a passenger next to the driver to assist the driver if the driver is having trouble seeing outside of the windshield due to the dynamically changing conditions, where both projections are augmented with the present AR-enabled highlighting of the assignment zones.

It should be noted that the focal point of each occupant may change frequently, therefore, data is continually fed from the sensor cluster to the processing system 126 and/or the edge server 140 so the focal point is continually monitored and calculated. Since the three dimensional coordinates of the source point of view are known (which may be determined to be the center point between the two eyeballs), the direction of an occupant's view, which is a line of sight from the source point of view to the focal point can be continually tracked, thereby allowing the present method to adjust the placement of the projection or overlay from the heads-up display unit relative to the fixed windshield of the vehicle.

In one embodiment, the edge server 140 can be tasked with making the various calculations discussed above for the processing system 126 if the vehicle has a processing system 126 that has limited processing capability. The placement of the edge server 140 at the edge of the access network 120 allows the communication network service provider to efficiently and quickly provide the present AR-enabled highlighting of the assignment zones as a service to the occupant of the vehicle. Since the vehicle may be traveling at a high rate of speed, the AR-enabled highlighting of the traffic markers must also be generated and presented on the projections of the heads-up display in a timely manner. By situating the edge server 140 at the edge of the access network 120, the calculated information can be delivered to the processing system 126 as quickly as possible. Pertinent map data can also be stored locally in the edge server 140 (e.g., pre-fetched) via communication with the DBs 106 and 108, thereby allowing the edge server 140 to quickly download the pertinent map data to a moving vehicle.

In one embodiment, the various sensors 130, including the cameras, on the vehicle, may be used to create a composite view of the surroundings of the vehicle 112. Since these camera locations are also fixed in relationship to the sensor arrays or clusters, the positioning of the images used to create the models of the surroundings are known in relation to the user's focal point on the windshield. Accordingly, with the relative location points known, the cameras may be used to sense the surroundings and, via image detection and analysis, identify where objects in the surroundings exist and what they are. For example, image analysis may be used to determine where lane markers and buildings are in the camera images. Knowing the positional relationship between the location of these lane markers and buildings and the relative focal point and direction of view of the driver, the processing system 126/edge server 140 may calculate and determine where on the vehicle's windshield to display augmented reality images (e.g., a projection or an overlay) that are representative of the items detected, such as lane markings and buildings, in such a way as for these lane markings and buildings to appear on the augmented reality display as either within or outside of an assignment zone.

In a like manner, the image analysis algorithm in the processing system 126/edge server 140 may detect objects such vehicles, pedestrians or other potential hazards and present a visualization (e.g., an animated, augmented, and highlighted version of these objects) in an overlay fashion to their actual location as it relates to the driver's point of view. In other words, moving objects such as vehicles, pedestrians or other potential hazards may be detected and presented on the heads up display of the dashboard in an augmented and highlighted manner relative to an assignment zone (e.g., within or outside). For example, an intruder within a building may be detected by a first responder who is currently on the scene of a dynamically changing event. This first responder may identify and mark this intruder and/or the building electronically, e.g., via a touch screen in the first responder vehicle 112 to highlight the intruder/building. In doing so, the processing system 126 may transmit this “marked” intruder/building and its location to edge server 140. In turn, the edge server 140 may transmit this information to all other first responder vehicles that are responding to this dynamically changing event and are heading toward the assignment zone that includes the marked intruder/building. In this example, the intruder/building may further be assigned as a new assignment zone, e.g., a new assignment zone within an existing assignment zone. This dynamic assignment zone approach allows for greater coordination between responding first responders, thereby avoiding confusion and delay. Thus, one aspect of the present disclosure is the focus of the assignment zones to be highlighted virtually via AR.

In one embodiment, one or more microphones in the sensor cluster may also detect spoken utterance requests from the driver as these utterances relate to the driver's field of view (e.g., “raise the HUD projection,” “lower the HUD projection,” “highlight a particular assignment zone (e.g., “show me only the marked assignment zones as marked by other first responders currently on the scene,” “show me the entire parameter of a campus in which a building as being marked by another first responder,” etc.), or “de-highlight a particular assignment zone” (e.g., “do not show me any other assignment zones except for the assignment zone currently assigned to a particular first responder vehicle”). That is, since there is now an association between the driver's focal point and viewable objects that correlate to the focal point, the image analysis and visualization capabilities of the processing system 126/edge server 140 may detect the presence of an item such as a marked building. Using the focal point detection capabilities described in this present disclosure, the driver may issue a verbal command (and based on the time at which the command is issued) that can be correlated to a marked assignment zone that was detected as being in the driver's focal point. Upon receiving the spoken command, the sensor cluster may send a request to the processing system 126/edge server 140 to pull the virtual image from the current visualization that is created and presented on the heads up display.

In some cases, the present solution may not be able to rely only on the information sensed by onboard sensors of the vehicle. For example, dynamically changing events may cause an assignment zone to be expanded or contracted based on the parameters of the dynamically changing event.

To illustrate, the edge server 140 may also be tasked with providing supplementary information to the processing system 126 in certain scenarios. For example, the edge server 140 may provide the supplementary information comprising at least one of: 1) roadway construction data (that defines the various roadway constructions on the road way, e.g., the type of construction), 2) roadway accident data (that defines any accidents on the roadway, e.g., the type of accidents such as car crashes, a car hitting an animal, a car leaving the roadway, a car on fire, a stalled car on the shoulder of the roadway, etc.), 3) roadway debris data (that defines any known debris on the roadway e.g., the type of debris such as a tire, a discarded safety cone, an animal, a tree limb, a rock, etc.), 4) assignment zones that have been marked by other responding first responders, 5) context information relating to the dynamically changing event e.g., the nature of the dynamically changing event (e.g., the type of emergency, a special parameter of the emergency such as spilling of a toxic material on the scene of the accident), the nature of any perpetrator at the scene (e.g., circumstances or descriptions associated with the perpetrator), the nature of any bystanders (e.g., any injured victims, the number of the injured victims, the type of injuries), and the like.

Such supplementary information may include the location (e.g., Global Positioning System (GPS) location information), the type, and/or the condition of any known objects or conditions of the assignment zones (e.g., for a stretch of roadway ahead of the vehicle, e.g., data for up to one mile, two miles, or three miles ahead of the vehicle). If the supplementary information is provided with sufficient accuracy (e.g., location, shape and size), the processing system 126 will be able to use the data contained in the supplementary information via augmented reality to improve visibility of assignment zones to assist drivers in navigating to and from the assignment zones.

In one embodiment, the edge server 140 is in communication with DBs 106 and 108 to obtain the necessary supplementary information to support the vehicle 112 given the vehicle's current location and its trajectory. In one embodiment, the edge server 140 may perform pre-processing on the supplementary information received from the DBs 106 and 108, where non-pertinent data in the supplementary information such as surrounding assignment zones can be intentionally removed or obscured (e.g., the non-pertinent objects being identified and segmented out or blurred from the image or the image size of the image can be cropped to not contain such non-pertinent objects) to reduce the size of the supplementary information that will be sent to the moving vehicle, thereby effecting a faster processing of the supplementary information for highlighting the relevant assignment zones for the driver of the moving vehicle.

In one example, the processing system 126/edge server 140 may send a query to an external database (e.g., DBs 106 and/or 108) that stores a record of locations of assignment zones. This database may have been populated at a previous time, for example, by a vehicle or other devices that mapped the location and conveyed coordinate data of various assignment zones.

In a similar manner, the augmented reality heads up display via the processing system 126 may be used or controlled to provide a projection for directional guidance indicators that are not sensed by onboard sensors such as cameras or others, but may be in response to specific broadcast instructions from a local guidance server, for example, that may be used to dictate a dynamic usage of a particular transport area such as a busy airport. As an example, an airport may have three terminals. During a dynamically changing event occurring at the airport, one or more terminals may be affected. In other words, the operation of the airport may be dynamically altered based on the dynamically changing event, e.g., an aviation accident, a security breach, a weather related accident, etc. Since an airport has its own dedicated first responders, e.g., dedicated airport fire fighters and dedicated airport police force, a local dispatcher at the airport may have the most up-to-date event information occurring at the airport. In one embodiment, this supplementary information (e.g., dynamic changing event information) may be sent from a local guidance server situated at the airport and presented on the augmented heads up display of the present disclosure.

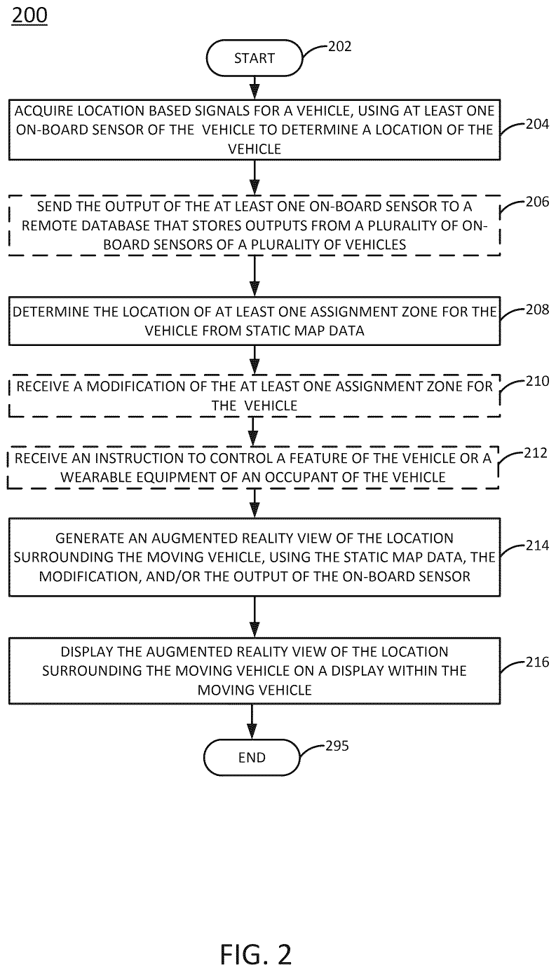

FIG. 2 illustrates a flowchart of an example method 200 for using augmented reality to improve visibility of assignment zones to assist first responders to quickly visualize changing assignment zones due to dynamically changing events. The steps, functions, or operations of the method 200 may be performed, for example, by the processing system of a vehicle, such as the processing system 126 illustrated in FIG. 1. In another example, the steps, functions, or operations of method 200 may be performed by a computing device or system 500, and/or processor 502 as described in connection with FIG. 5 below. Similarly, in one example, the steps, functions, and/or operations of the method 200 may be performed by a processing system comprising one or more computing devices collectively configured to perform various steps, functions, and/or operations of the method 200. For instance, multiple instances of the computing device or processing system 500 may collectively function as a processing system. For illustrative purposes, the method 200 is described in greater detail below in connection with an example performed by a processing system, such as processor 502.

The method 200 begins in step 202. In step 204, the processing system may acquire location based signals surrounding a moving vehicle for assisting the determination of a current location (broadly location information) associated with the vehicle, using at least one on-board sensor of the moving vehicle. In one example, the moving vehicle may include a plurality of on-board sensors that detect and acquire location based signals such as global positioning system (GPS) signals. For example, on-board unit (OBU) or a vehicle master controller of the vehicle may include a global positioning system (GPS) navigation unit or receiver that receives GPS signals from GPS satellites, thereby enabling the vehicle to determine its location (e.g., calculating GPS coordinates in latitude and longitude, or the like). In another example, the physical location of the vehicle may be determined through a triangulation process based on the locations of base stations of a radio access network with which the vehicle can communicate with. Other methods of acquiring the location information of the vehicle can be used. In one example, the on-board sensors may include at least one of: a sonar system, a lidar system, a radar system, a camera (e.g., RGB and/or infrared video camera) system, a GPS receiver unit, a moisture sensor, a proximity sensor, a light sensor, a barometer, a thermometer, an anemometer, a compass, or another type of sensor. The measurements provided by any of these on-board sensors may be analyzed by the processing system in order to detect the presence and location of weather events, other objects (e.g., other vehicles, pedestrians, road obstructions, etc.), the current location of the vehicle, and the like, as discussed in greater detail below.

In optional step 206 (illustrated in phantom), the processing system may send the output of the at least one on-board sensor to a remote database that stores outputs of a plurality of on-board sensors of a plurality of vehicles. In one example, a remote database (e.g., DB 106 or 108) may collect measurements from the on-board sensors of a plurality of vehicles (which may include moving and non-moving vehicles), where each vehicle of the plurality of vehicles may include on-board sensors such as those described above. In one example, each measurement (including the output of the on-board sensor that is sent by the processing system) may include metadata identifying at least one of: a location at which the measurement was measured (e.g., GPS coordinates, longitude and latitude, highway exit markers, street names, zip codes, city, landmarks (e.g., bridges, tunnels, toll booths, railroad stations, and the like), or other positional identifiers), a time at which the measurement was measured, a vehicle from which the measurement was received (e.g., a unique identifier that identifies a single vehicle), and/or other information.

In one example, users may opt into sharing the outputs of their vehicles' on-board sensors with the remote database, e.g., as part of a subscription-based service. For instance, users may subscribe to a service whereby the users' vehicles are assigned unique identifiers. Subsequently, when the users are operating their vehicles, data measured by the on-board sensors of the vehicles may be marked with the vehicles unique identifiers and shared with the remote database. When necessary, data measured by the on-board sensors of other vehicles may be shared by the database with the vehicles, as discussed in greater detail below.

In step 208, the processing system may determine the location (e.g., geo-fenced location or boundaries) of at least one assignment zone for the vehicle, e.g., from static map data. To illustrate, a local police department may have a predefined list of assignment zones for each police officer and/or each police cruiser for each shift of the day. For example, the local police department of a town may have dissected the town into a plurality of assignment zones that are pre-allocated to its staff of police officers, i.e., each police officer is assigned a beat (an assignment zone) for patrol purposes. Thus, under normal circumstances, each police officer is aware of the assignment zone that has been previously assigned to him or her. In one example, the plurality of assignment zones is provided as static map data so that each vehicle is informed as to all of the plurality of assignment zones that could be assigned to a police officer and/or a police cruiser. In other words, static map data may have the geographical boundaries of each of the plurality of assignment zones. For definition purposes, the term “boundary” refers to a single side of an assignment zone, whereas the term “boundaries” refers to all sides surrounding an assignment zone. Thus, the term “at least one boundary” refers to one or more sides surrounding an assignment zone.

In one embodiment, the processing system may acquire static map data for the location surrounding the moving vehicle. In one example, the static map data may be obtained from a remote server (e.g., a map generation server). For instance, the remote server may retrieve the static map data from one or more databases, where each database of the one or more databases may be operated by a different entity (e.g., a commercial entity, a governmental entity, an educational entity, or the like). In one example, the static map data stored in the databases may comprise GPS coordinates, maps and/or images of a plurality of locations having unique notable markers, where the static map data does not change substantially over time. For instance, the static map data may comprise historical street level views or images of the location surrounding the moving vehicle with permanent traffic markers such as roadway lane lines, street signs, stop signs, yield signs, exit signs, traffic lights, and so on.

In one embodiment, the determining step of 208 can be activated by an occupant of the vehicle, e.g., the driver of the vehicle may want a visual aid to ascertain various boundaries of various assignment zones. Alternative, the determining step of 208 can be activated remotely by a network application server, e.g., from a dispatcher system altering the assignment zone for a first responder or a first responder vehicle, e.g., receiving a control signal from a remote server.

In step 210, the processing system may optionally receive a modification to the at least one assignment zone. In one embodiment, the modification to the at least one assignment zone may comprise completely replacing the at least one assignment zone with a completely different assignment zone, e.g., reassigning a first responder from a first assignment zone (e.g., a downtown area of a city) to a second assignment zone (e.g., an airport just outside of the city), and so on. In another embodiment, the modification to the at least one assignment zone may comprise increasing or expanding the size of the at least one assignment zone by a certain amount, e.g., expanding a first assignment zone assigned to a first responder from an uptown area of a city to include a downtown area of the city as well (e.g., due to another first responder who used to be assigned to the downtown area being reassigned to an airport just outside of the city). In yet another embodiment, the modification to the at least one assignment zone may comprise decreasing or shrinking the size of the at least one assignment zone by a certain amount, e.g., reducing the size of a first assignment zone assigned to a first responder from a downtown area of a city to a particular campus, a particular block, or a particular building of the downtown area (e.g., due to a dynamically changing event, e.g., a perpetrator being spotted at the particular campus, the particular block, or the particular building of the downtown area).

In one embodiment, the processing system may receive the modification with dynamic map data. In one example, the dynamic map data stored in the databases may comprise maps and/or images of a plurality of locations having current event data, where the dynamic map data will change substantially over time. For instance, the dynamic map data may comprise historical street level views or images of the location surrounding the moving vehicle updated with current event data such as a recent traffic accident, temporary car accident debris on a road (e.g., crashed vehicles or parts of the crashed vehicles), temporary environmental debris (e.g., a landslide, fallen rocks or boulders, fallen trees or tree limbs, etc.), temporary weather related debris (e.g., debris left on a roadway from a storm like a hurricane) and so on. In a related embodiment, dynamic map data may include a prioritization change for a specific zone. Specifically, contextual events accidents, crime, or user triggered events may change the priority of a zone, causing it to grow or shrink within the visualization for one or more users.

More specifically, optional step 210 may acquire real time sensor data for the location surrounding the moving vehicle, where the real time (e.g., dynamic) sensor data comprises outputs of a plurality of on-board sensors of a plurality of other vehicles (i.e., vehicles other than the moving vehicle). In one embodiment, it should be noted that “real time” sensor data may comprise “near real time” sensor data relative to the perspective of a current vehicle, e.g., within a predefined amount of time occurring before the current time. For example, an earlier first responder vehicle traveling on the same roadway ahead of a current first responder vehicle (e.g., one minute ahead, two minutes ahead, five minutes ahead, and so on). Alternative, in another embodiment, the other first responder vehicles may simply be other first responder vehicles traveling alongside a current first responder vehicle, but these other first responder vehicles may have a slightly different locations (i.e., different perspectives) relative to the current first responder vehicle (e.g., in neighboring lanes on a multi-lane highway, etc.), where “real time” sensor data can be acquired (e.g., images from a first responder vehicle traveling on a local lane may reveal an accident ahead more clearly than images taken from a first responder vehicle traveling on an express lane).

In one example, the real time sensor data may be acquired from the remote server from which the static map data was obtained in step 208. For instance, the remote server may retrieve the real time sensor data from a remote database, such as the database (e.g., DB 106 or DB 108) to which the processing system sent via the on-board sensor output in step 206. As discussed above, the real time sensor data stored in the remote database may comprise on-board sensor data collected from a plurality of vehicles, where the real time sensor data may change continuously over time. For instance, the real time sensor data may comprise data indicative of weather conditions (e.g., precipitation, wind, or the like), traffic conditions (e.g., accidents, construction sites, obstructions, down trees, or the like), or other conditions. The real time sensor data may be associated with metadata indicating when (time) and where (location) the real time sensor data was measured or collected. In some examples, real time sensor data may age out of the remote database after a threshold period of time. For instance, all real time sensor data may be automatically deleted from the remote database after z minutes, e.g., z may be 5 minutes, 10 minutes, 15 minutes, 60 minutes, 120 minutes, etc. The real time sensor data may, however, continually be replaced in the remote database with more recent real time sensor data.

In another example, the real time sensor data may be obtained directly from the plurality of vehicles. For instance, direct first responder vehicle-to-vehicle communications (peer-to-peer communication) may allow first responder vehicles to share their respective real time sensor data directly, decreasing the latency with which the real time sensor data is acquired by the processing system. In some embodiments, the degree of peer-to-peer communication may also be changed such that the plurality of vehicles may begin to modify the sensors operation (and their capture of sensor data) to specifically aide the first vehicle instead of their own normal operations, like faster capture rate, narrower focal length, alternate frequency filtering or specific object detection, etc.

In optional step 212, the processing system may receive an instruction to control (e.g., activate or deactivate) a feature of the vehicle or wearable equipment of an occupant of the vehicle. For example, a police officer or a police cruiser may be reassigned to a different assignment zone, e.g., due to a dynamically changing event such as a perpetrator being spotted at a school. In one embodiment, the dash camera of the vehicle and/or the body camera worn on the shirt of the officer may be activated to start recording. In one embodiment, the activation of this feature of the vehicle or the wearable equipment of the occupant of the vehicle may not be disabled by the driver of the vehicle or the occupant of the vehicle wearing the wearable equipment, e.g., until another instruction is received having a deactivation code or the police officer or the police cruiser is reassigned back to an original assignment zone. Other features may include the intensity of a vehicle siren, the intensity of one or more lights of the vehicle, the disengagement/engagement of a latch holding a particular type of firearm stored inside the vehicle, the removal/engagement of a speed limiting device on the vehicle that can limit how fast the vehicle can travel at, and so on. In other words, certain assignment zones may have different requirements that will cause certain features to be altered, e.g., activated, deactivated, reduced in intensity, increased in intensity, etc.

In step 214, the processing system may generate an augmented reality view of the location surrounding the moving vehicle 112, using the static map data, the dynamic map data (e.g., real time sensor data of other vehicles 110, 114, or 116), and/or the output of the at least one on-board sensor. In one example, the augmented reality view may comprise a view of the location surrounding the moving vehicle where AR-enabled highlighting of at least one assignment zone is provided, e.g., AR-enabled highlighting of at least one boundary of at least one assignment zone. “Highlighting” of the assignment zones may comprise creating and presenting a virtual image of the assignment zones, e.g., creating and displaying one or more virtual boundaries associated with the at least one assignment zone. Alternatively, “highlighting” of the traffic markers may comprise creating and presenting a virtual image effect surrounding the at least one assignment zone, e.g., creating and displaying a virtual overlay color, shading, or vibrating effect over an actual roadway, a campus area of a school or a corporate park, a particular building within the campus area, an entrance to a building, etc. In other words, in one embodiment the “highlighting” of the traffic marker may only require an emphasizing effect to be placed over the actual object or landmark, e.g., creating and superimposing a virtual marker or effect onto a virtual projection. For instance, the augmented reality view may present a video image of the roadway ahead of the moving vehicle, where the video image may be digitally altered to highlight one or more buildings or entrances to the one or more buildings that are part of at least one assignment zone that is likely to be of interest to an occupant of the vehicle. As an example, if the moving vehicle is driving up to a campus area with many buildings, the augmented reality view may comprise a video image of the campus area with many buildings but with one particular building being virtually highlighted with a marker, e.g., on a heads up display. In this illustrative example, the campus area can be a first assignment zone, and the particular highlighted building can be a second assignment zone, e.g., the second assignment zone is within the first assignment zone. This may greatly help the driver to navigate the moving vehicle through the campus area to the particular building quickly, even though the driver has yet to fully assess the situation in the campus area.

In step 216, the processing system may display the augmented reality view of the location surrounding the moving vehicle on a display within the moving vehicle. For instance, the moving vehicle may include a heads up display, a dashboard display, an AR-enabled windshield, or another type of display on which the AR view may be displayed to the driver of the moving vehicle. As discussed above, this may help the driver to navigate the moving vehicle through the one or more assignment zones.

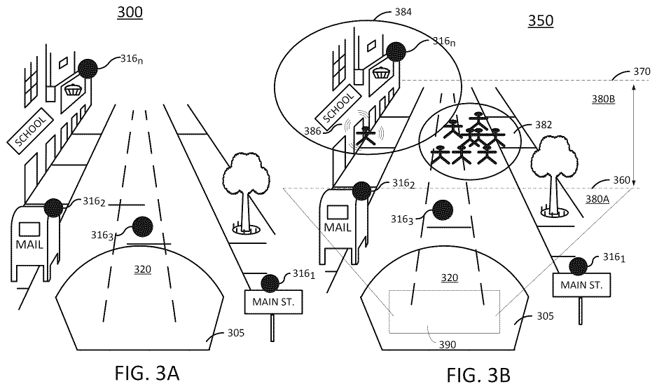

FIG. 3A, for instance, illustrates an example in which there is street view 300 ahead of a vehicle, e.g., a car, on a road 320 through the car's windshield 305. FIG. 3B illustrates an AR view 350 of the road 320 of FIG. 3A, in which at least one boundary 360 or 370 of at least one assignment zone 380A and/or 380B may be digitally highlighted so that the delineations of the at least one assignment zone 380A and/or 380B can be made more visible. For example, as a vehicle is traversing down the road 320 of FIG. 3A, the driver in this vehicle is unable to clearly determine the boundary 360 separating assignment zone 380A (an assignment zone not including the school) from assignment zone 380B (an assignment zone including the school). In one illustrative example, various position sensors 316₁-316ₙ are deployed in the environment traversed by the vehicle. For example, position sensors 316₁-316ₙ may broadcast signals that a signal receiver on the vehicle may detect to facilitate the determination of location or displacement information in terms of a three-dimensional space, e.g., calculating a linear travel, a rotational angle, and the like with respect to the moving vehicle carrying the windshield 305.

In contrast, when the present AR-enabled highlighting of the at least one assignment zone is activated, the boundary 360 separating assignment zone 380A (the assignment zone not including the school) from assignment zone 380B (the assignment zone including the school) can now be presented with an AR projection on a display 390 showing virtual markers (e.g., virtual dashed lines) that extend across the roadway 320 as shown in FIG. 3B. In one example, the first responder or the first responder vehicle may receive a modification to its assignment zone, e.g., the assignment zone boundary 360 is dynamically extended from assignment zone 380A into the assignment zone 380B temporarily, e.g., during a recess time period where a large of school children 382 may traverse outside of the school.

In yet another example, the first responder or the first responder vehicle may receive a modification to its assignment zone, e.g., the assignment zone boundary 360 is dynamically extended from assignment zone 380A into the assignment zone 380B temporarily, e.g., due to a detection or a reporting of an intruder at the school. Thus, as the first responder is approaching assignment zone 380B, the AR projection on the display 390 will now clearly show that the boundary 360 has been extended to boundary 370 where the school is now within the assignment zone assigned to the first responder or to the first responder vehicle. The potential intruder or an entrance to the school where the potential intruder is likely to be found can also be highlighted with an effect 386 (e.g., where the virtual marker is slightly vibrating or shifting left and right to further highlight the virtual marker, or a highlighting effect where the virtual marker is highlighted with a color, or where the virtual marker is flashing) or assigned as yet another assignment zone. This AR projection will allow a first responder to quickly ascertain the situation as to the boundaries of the assignment zone so that the first responder is able to quickly navigate to the relevant locations to provide the necessary services within the assigned assignment zone upon arrival. Thus, the AR view may be displayed on a display within the vehicle, as discussed above.

Steps 204-216 may be repeated as necessary, e.g., such that the AR view continually presents a modified view of the road ahead of the moving vehicle as to one or more assignment zones to allow improved visibility to an occupant (e.g., a driver) of the vehicle. The method 200 may end in step 295.

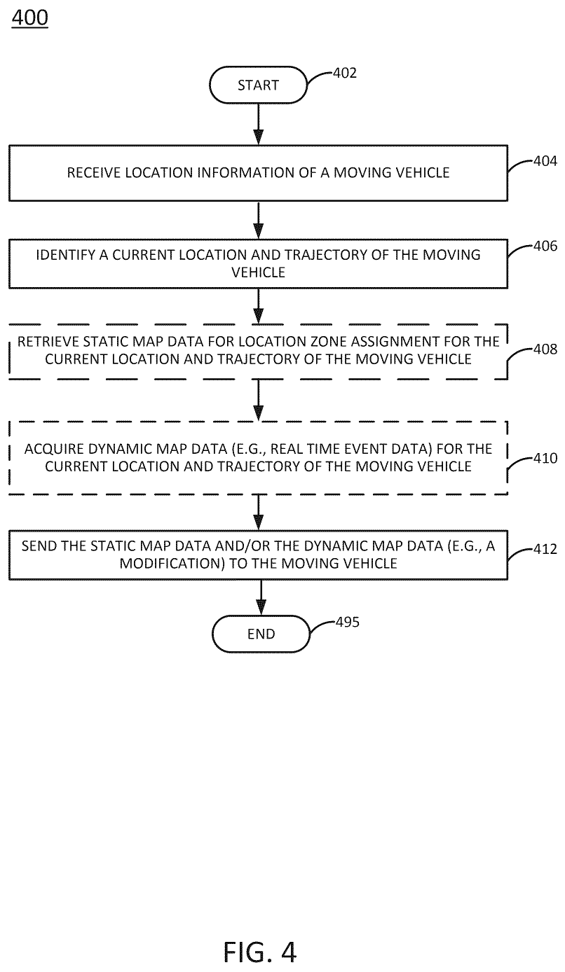

FIG. 4 illustrates a flowchart of an example method 400 for providing augmented reality maps (e.g., static map data and/or dynamic map data with real time data) to assist drivers in navigating to and from assignment zones, e.g., to control the highlighting of assignment zones using AR to delineate at least one assignment zone. The steps, functions, or operations of the method 400 may be performed, for example, by an application server, such as the AS 104 illustrated in FIG. 1. In another example, the steps, functions, or operations of method 400 may be performed by a computing device or system 500, and/or processor 502 as described in connection with FIG. 5 below. Similarly, in one example, the steps, functions, and/or operations of the method 400 may be performed by a processing system comprising one or more computing devices collectively configured to perform various steps, functions, and/or operations of the method 400. For instance, multiple instances of the computing device or processing system 500 may collectively function as a processing system. For illustrative purposes, the method 400 is described in greater detail below in connection with an example performed by a processing system, such as processor 502.

The method 400 begins in step 402. In step 404, the processing system may receive one or more signals from a vehicle (e.g., a moving vehicle), where the signal contains location information related to the moving vehicle, e.g., GPS coordinates of the moving vehicle.

In step 406, the processing system may identify the current location of the vehicle and its trajectory if the vehicle is moving. Namely, the location information may contain a sequence of GPS coordinates thereby allowing the processing system to ascertain the current location of the vehicle and its trajectory if the vehicle is moving. For instance, metadata associated with the location information may indicate the current location (e.g., GPS coordinates, longitude and latitude, highway exit markers, street names, zip codes, city, landmarks, or other positional identifiers) of the moving vehicle and the moving vehicle's trajectory (e.g., a path to a destination that has been programmed into a navigation application, a predefined distance ahead on a road currently traveled by the moving vehicle, etc.).

In another example, the processing system may identify the current location and trajectory of the moving vehicle by first identifying the moving vehicle. For instance, if the moving vehicle is subscribed to an AR assisting service, then the moving vehicle may be associated with a unique account number or other vehicle identifiers. The vehicle identifier may be used as an index to a database that stores real time sensor data for a plurality of vehicles subscribed to the AR assisting service. For instance, each instance of real time sensor data stored in the database may be tagged with metadata to indicate the source of the instance of real time sensor data. The processing system may search the database for instances of real time sensor data for which the source is the moving vehicle, and may then identify from among those instances that real time sensor data that was recorded most recently in the database (e.g., has the most recent timestamp). This may give an approximation of the current location and trajectory of the moving vehicle by first identifying the moving vehicle.

In step 408, the processing system may retrieve static map data for the current location and trajectory of the moving vehicle with highlighting of the assignment zones. In one example, the processing system may use the current location and trajectory of the moving vehicle (determined in any of the ways discussed above) as an index into a database that stores maps and/or images of a plurality of locations, where the static map data does not change substantially over time. For instance, the static map data may comprise historical street level views or images of the location surrounding the moving vehicle. The processing system may search the database for any static map data that is tagged with metadata that matches the current location and trajectory of the moving vehicle. More specifically, the static map data is specifically obtained to assist in the highlighting of assignment zones shown or displayed in the static map data.

In optional step 410, the processing system may acquire dynamic map data (e.g., real time sensor data from other vehicles) for the current location and trajectory of the moving vehicle, i.e., where the real time sensor data may comprise data measured by an on-board sensor of at least one other vehicle. In one example, the processing system may use the current location and trajectory of the moving vehicle (determined in any of the ways discussed above) as an index into a database that stores real time sensor data for a plurality of vehicles subscribed to the AR assignment zone mapping service. For instance, each instance of real time sensor data stored in the database may be tagged with metadata to indicate the time and location at which the real time sensor data was recorded. The processing system may search the database for instances of real time sensor data for which the location matches the current location or the trajectory of the moving vehicle.

In step 412, the processing system may send the static map data and/or the dynamic map data (e.g., real time sensor data) to the moving vehicle. Alternatively, in one embodiment the processing system may generate and then send the augmented reality view of one or more assignment zones surrounding the moving vehicle with highlighting of the one or more assignment zones to the moving vehicle. In other words, in one embodiment, the augmented reality view of conditions surrounding the moving vehicle with highlighting of the assignment zones can be generated externally from the moving vehicle and then transmitted to the moving vehicle. Such embodiment can be achieved if there is sufficient transmission bandwidth between the moving vehicle and the application server 104 or edge server 140.

As discussed above, a processing system of the moving vehicle may use the static map data and/or the dynamic may data to generate an AR view of the environment surrounding the moving vehicle with highlighting of assignment zones, where the AR view may digitally highlight various assignment zones.

Steps 404-412 may be repeated as necessary, e.g., such that the processing system continually sends updated static map data and/or dynamic map data to the moving vehicle based on the movement of the moving vehicle, allowing the processing system of the moving vehicle to continually present a modified view of the road ahead of the moving vehicle with the highlighting of assignment zones. The method 400 may end in step 495.

Although not expressly specified above, one or more steps of the method 200 or the method 400 may include a storing, displaying and/or outputting step as required for a particular application. In other words, any data, records, fields, and/or intermediate results discussed in the method can be stored, displayed and/or outputted to another device as required for a particular application. Furthermore, operations, steps, or blocks in FIG. 2 of FIG. 4 that recite a determining operation or involve a decision do not necessarily require that both branches of the determining operation be practiced. In other words, one of the branches of the determining operation can be deemed as an optional step. Furthermore, operations, steps or blocks of the above described method(s) can be combined, separated, and/or performed in a different order from that described above, without departing from the example embodiments of the present disclosure.

FIG. 5 depicts a high-level block diagram of a computing device specifically programmed to perform the functions described herein. For example, any one or more components or devices illustrated in FIG. 1 or described in connection with the method 200 or method 400 may be implemented as the system 500. For instance, a connected vehicle or an application server could be implemented as illustrated in FIG. 5.

As depicted in FIG. 5, the system 500 comprises a hardware processor element 502, a memory 504, a module 505 for using augmented reality to improve visibility of assignment zones to assist first responders to quickly visualize changing assignment zones due to dynamically changing events, and various input/output (I/O) devices 506.

The hardware processor 502 may comprise, for example, a microprocessor, a central processing unit (CPU), or the like. The memory 504 may comprise, for example, random access memory (RAM), read only memory (ROM), a disk drive, an optical drive, a magnetic drive, and/or a Universal Serial Bus (USB) drive. The module 505 for using augmented reality to improve visibility of assignment zones to assist first responders to quickly visualize changing assignment zones due to dynamically changing events may include circuitry and/or logic for performing special purpose functions relating to generating augmented reality maps. The input/output devices 506 may include, for example, a camera, a video camera, storage devices (including but not limited to, a tape drive, a floppy drive, a hard disk drive or a compact disk drive), a receiver, a transmitter, a speaker, a microphone, a transducer, a display, a speech synthesizer, a haptic device, a sensor, an output port, a display, an on-board sensor, a sonar sensor, a lidar sensor, or a user input device (such as a keyboard, a keypad, a mouse, and the like).

Although only one processor element is shown, it should be noted that the dedicated computer may employ a plurality of processor elements. Furthermore, although only one computer is shown in the FIG. 5, if the method(s) as discussed above is implemented in a distributed or parallel manner for a particular illustrative example, i.e., the steps of the above method(s) or the entire method(s) are implemented across multiple or parallel computers, then the computer of this Figure is intended to represent each of those multiple computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computer or any other hardware equivalents, e.g., computer readable instructions pertaining to the method(s) discussed above can be used to configure a hardware processor to perform the steps, functions and/or operations of the above disclosed method(s). In one example, instructions and data for the present module or process 505 for using augmented reality to improve visibility of assignment zones to assist first responders to quickly visualize changing assignment zones due to dynamically changing events (e.g., a software program comprising computer-executable instructions) can be loaded into memory 504 and executed by hardware processor element 502 to implement the steps, functions or operations as discussed above in connection with the example method 200 or example method 400. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 505 for using augmented reality to improve visibility of assignment zones to assist first responders to quickly visualize changing assignment zones due to dynamically changing events (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of example only, and not limitation. Thus, the breadth and scope of a disclosed example should not be limited by any of the above-described examples, but should be defined only in accordance with the following claims and their equivalents.

What is claimed is:

1. A method comprising:
monitoring, by a processing system including at least one processor, at least one location based signal for a vehicle, using at least one on-board sensor of the vehicle to determine a location of the vehicle;
determining, by the processing system, at least one assignment zone for the vehicle based on static map data;
generating, by the processing system, an augmented reality view of the location surrounding the vehicle, using the static map data for highlighting the at least one assignment zone at the location surrounding the vehicle; and
displaying, by the processing system, the augmented reality view of the location surrounding the vehicle with the at least one assignment zone being highlighted on a display within the vehicle.

2. The method of claim 1, wherein the vehicle is a moving vehicle on a roadway.

3. The method of claim 1, wherein the at least one on-board sensor comprises at least one of: a position signal receiver, a sonar system, a light detection and ranging system, a radar system, a camera system, a global positioning system, a moisture sensor, a proximity sensor, a light sensor, a barometer, a thermometer, or an anemometer.

4. The method of claim 1, further comprising:
receiving, by the processing system, an instruction for modifying the at least one assignment zone.

5. The method of claim 1, wherein the determining is in response to receiving a signal from an occupant of the vehicle.

6. The method of claim 1, wherein the determining is in response to receiving a control signal from a remote server.

7. The method of claim 1, wherein the static map data comprises historical street level views or images of the location surrounding the vehicle.

8. The method of claim 1, further comprising:
acquiring, by the processing system, dynamic map data for the location surrounding the vehicle.

9. The method of claim 8, wherein the dynamic map data comprises real time sensor data for the location surrounding the vehicle, where the real time sensor data comprises outputs of a plurality of on-board sensors of a plurality of other vehicles.

10. The method of claim 9, wherein the real time sensor data for the location surrounding the vehicle comprises at least one of: data indicative of a second assignment zone within the at least one assignment zone.

11. The method of claim 8, wherein the dynamic map data is acquired directly from another vehicle.

12. The method of claim 8, wherein the dynamic map data is acquired from a remote server in communication with a database that receives the dynamic map data from a plurality of other vehicles.

13. The method of claim 1, wherein the at least one assignment zone comprises a plurality of boundaries, and wherein the highlighting comprises generating a virtual image in which at least one boundary of the plurality of boundaries is presented on the display.

14. The method of claim 1, further comprising:
receiving, by the processing system, an instruction for controlling a feature of the vehicle based on the at least one assignment zone.

15. The method of claim 14, wherein the controlling the feature comprises at least one of: activating the feature, deactivating the feature, increasing an intensity of the feature, or increasing an intensity of the feature.

16. The method of claim 14, wherein the features comprises at least one of: a camera deployed on the vehicle, a siren deployed on the vehicle, an electronic latch deployed on the vehicle, a speed limiting unit deployed on the vehicle, or a light deployed on the vehicle.

17. The method of claim 1, further comprising:
receiving, by the processing system, an instruction for controlling a feature of a wearable device worn by an occupant of the vehicle based on the at least one assignment zone, wherein the wearable device comprises a body camera.

18. The method of claim 1, wherein the display comprises at least one of: a heads up display, a dashboard display, or an augmented reality-enabled windshield.

19. A non-transitory computer-readable storage medium storing instructions which, when executed by a processing system including at least one processor, cause the processing system to perform operations, the operations comprising:
monitoring at least one location based signal for a vehicle, using at least one on-board sensor of the vehicle to determine a location of the vehicle;
determining at least one assignment zone for the vehicle based on static map data;
generating an augmented reality view of the location surrounding the vehicle, using the static map data for highlighting the at least one assignment zone at the location surrounding the vehicle; and
displaying the augmented reality view of the location surrounding the vehicle with the at least one assignment zone being highlighted on a display within the vehicle.

20. A system comprising:
a processing system including at least one processor; and
a non-transitory computer-readable medium storing instructions which, when executed by the processing system, cause the processing system to perform operations, the operations comprising:
monitoring at least one location based signal for a vehicle, using at least one on-board sensor of the vehicle to determine a location of the vehicle;
determining at least one assignment zone for the vehicle based on static map data;
generating an augmented reality view of the location surrounding the vehicle, using the static map data for highlighting the at least one assignment zone at the location surrounding the vehicle; and
displaying the augmented reality view of the location surrounding the vehicle with the at least one assignment zone being highlighted on a display within the vehicle.
